(19) United States
(12) Patent Application Publication
(10) Pub. No.: US 2008/0099533 A1
(43) Pub. Date: May 1, 2008

(54) METHOD FOR CONTROLLING MICROSTRUCTURE VIA THERMALLY MANAGED SOLID STATE JOINING

(75) Inventors: Timothy Hanlon, Glenmont, NY (US); Pazhayannur Ramanathan Subramanian, Niskayuna, NY (US); Earl Claude Helder, Cincinnati, OH (US); Timothy Joseph Trapp, Columbus, OH (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC, Schenectady, NY (US)

(21) Appl. No.: 11/554,751

(22) Filed: Oct. 31, 2006

(51) Int. Cl. B23K 20/12

(52) U.S. Cl. 228/112.1

(57) ABSTRACT

A method for creating a solid state joint is disclosed. The method includes providing an adjoining apparatus that includes a pin tool, a backing plate and a thermal control plate disposed below the backing plate. The method also includes rotating the pin tool and traversing the pin tool relative to a workpiece along a joint to be welded on the workpiece. The method further includes manipulating the temperature of the pin tool and the backing plate in order to control the temperature and rate of change of temperature experienced by the workpiece at a weld affected zone at the joint. The method also includes maintaining a user chosen temperature differential between the weld affected zone and the backing plate via the thermal control plate.

### BACKGROUND

The invention relates generally to solid state welding technology, and more particularly to friction welding.

In recent years, there has been a considerable effort put into designing and building powerful and efficient turbo-machinery such as gas turbine engines. The design involves use of materials having properties such as enhanced high temperature performance and strength, or advantageous strength-to-weight ratios. However, an increased susceptibility to cracking and other defect generation, including unacceptable property degradation, was observed in such materials when joined by conventional welding technology.

Solid state welding or joining processes have been developed as a way of addressing these issues. One of the more successfully employed techniques is friction stir welding. Friction stir welding is regularly used to join metals and metal alloys. The friction stir welding technique overcomes a number of problems associated with other more conventional joining techniques. In a typical friction stir welding process, a rotating, often cylindrical, non-consumable tool such as a pin tool is plunged into a rigidly clamped workpiece at a location containing a joint to be welded. The rotating tool can be traversed along the joint to be welded, held in place as the workpiece is fed past the tool, or any combination of the two. As the weld progresses, the workpiece material within the joint vicinity becomes a plasticized (non-liquid) metal, metal alloy or other material, and workpiece material from all components of the joint transfers across a joint interface co-mingling to form a strong cohesive bond between all workpiece components through a localized solid-state forging and/or extrusion action.

During the friction stir welding process, elevated temperatures are generated in the tool. The high temperatures in the tool, in combination with relatively high pre weld workpiece heating rates and high post-weld workpiece cooling rates, may result in a weld joint of poor quality, such as poor mechanical strength and toughness often but not always attributable to defects, undesirable material structure, and workpiece distortions.

Therefore, a need exists for an improved welding or a joining system that would address problems set forth above.

### BRIEF DESCRIPTION

In accordance with an embodiment of the invention, a method for creating a solid state joint is provided. The method includes providing an adjoining apparatus. The adjoining apparatus includes a tool, a backing plate and a thermal control plate disposed below the backing plate. The method also includes rotating the tool and traversing the tool along a joint to be welded on a stationary workpiece. Alternatively, the workpiece can be fed past a stationary rotating pin tool. Additionally, the rotating tool and workpiece can be mobile. The method further includes manipulating the temperature of the tool and the backing plate in order to control the temperature and rate of change of temperature experienced by the workpiece, and to enable pre-weld, post-weld, and in-situ control over the thermal profile at a weld affected zone at the joint. The method also includes maintaining a user chosen temperature differential between the weld affected zone and the backing plate via the thermal control plate.

In accordance with another embodiment of the invention, a method of operation is provided. The method includes monitoring temperature of a weld-affected zone. The method also includes applying a temperature control via a thermal control plate based upon the temperature that is monitored. The method further includes maintaining the temperature to about 50 to about 80 percent of melting temperature of the workpiece.

### DRAWINGS

These and other features, aspects, and advantages of the present invention will become better understood when the following detailed description is read with reference to the accompanying drawings in which like characters represent like parts throughout the drawings, wherein:

FIG. 1 is a sectional end view of a friction stir welding apparatus including a backing plate and a thermal control plate for thermal management;

FIG. 2 is a diagrammatical illustration of a top view of the backing plate and the thermal control plate of FIG. 1 used for temperature control;

FIG. 3 is a diagrammatical illustration of an exemplary embodiment of temperature control via the thermal control plate of FIG. 1

FIG. 4 is a diagrammatic illustration of a weld affected zone showing various regions along an axis of the weld affected zone;

FIG. 5 is a flow chart illustrating exemplary steps for a method of creating a solid state joint; and

FIG. 6 is a flow chart illustrating exemplary steps for a method of controlling temperature during a process of creating a solid state joint.

### DETAILED DESCRIPTION

As discussed in detail below, embodiments of the present invention provide a method for controlling microstructure and hence improving properties of a material during a solid state joining technique via thermal management of the material through controlled use of the welding apparatus. Some non-limiting examples of the properties of a material in solid state joints include yield strength, ultimate tensile strength, ductility, impact toughness, fracture toughness, fatigue crack growth resistance, low cycle fatigue resistance, high cycle fatigue resistance, and superplastic formability. In an example, the solid state joining includes a friction stir welding technique. The friction stir welding technique may be used to join one or more similar or dissimilar materials forming a workpiece. Some non-limiting examples of materials include metals, metal alloys, and thermoplastics. The term ‘controlling microstructure’ used herein refers to non-limiting examples such as controlling grain size, phase content, phase morphology and phase spatial distribution, and avoiding harmful phase transitions in materials at solid state joints.

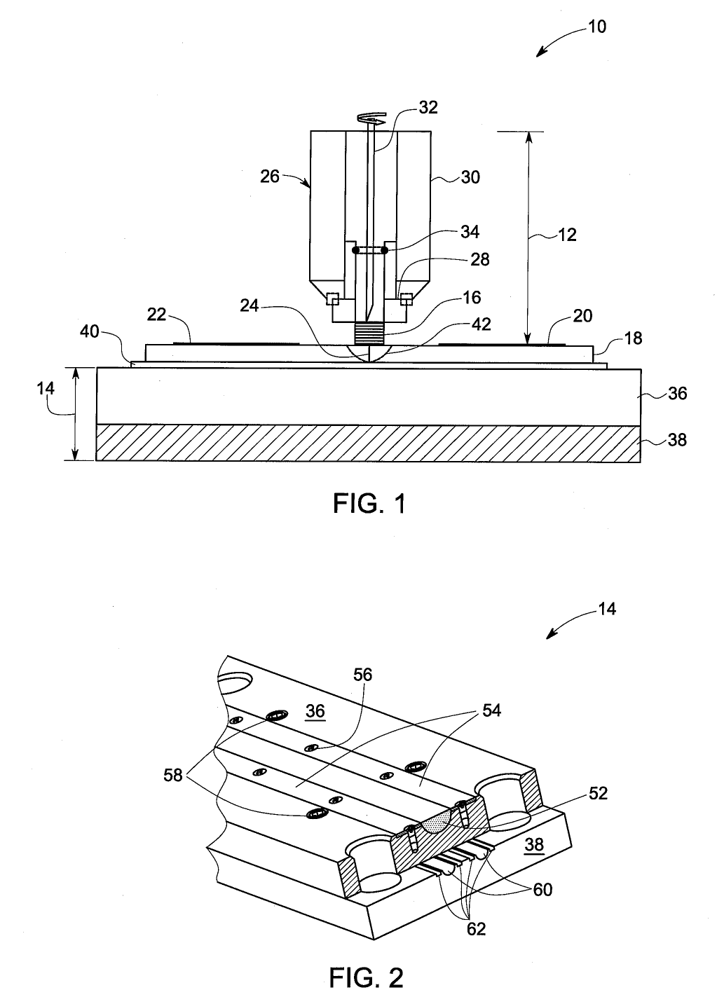

FIG. 1 is a diagrammatical illustration of a sectional end view example of an exemplary thermally managed friction stir welding apparatus 10. The thermally managed friction stir welding apparatus 10 includes a pin tool apparatus 12 and a thermal management system 14. The pin tool apparatus 12 includes a rotating pin tool 16. In a particular embodiment, the pin tool 16 may include a cylindrical shape with a plurality of threads or truncations. In another embodiment, the pin tool 16 may include a conical shape with a plurality of threads or truncations. In another example, the pin tool 16 may be unthreaded. In an example, the pin tool 16 may be non-consumable. In another example, the pin tool 16 may be consumable and a portion of the pin tool material may be stirred into the solid state joint or deposited onto the workpiece. The pin tool 16 may be selectively plunged into a rigidly clamped workpiece 18. The workpiece 18 may include one or more similar or dissimilar materials to be welded. In a particular embodiment as shown in FIG. 1, the workpiece 18 may include two similar or dissimilar materials 20 and 22 disposed adjacent to one another and forming a joint 24 to be welded. In a particular embodiment, the joint 24 may have a length of between about 1 inch and about 300 inches. In another embodiment, the joint 24 may be circumferential, contoured, or any combination between.

The pin tool 16 may be rotated at varying speeds depending upon the materials 20 and 22 to be welded. In a specific embodiment, the pin tool 16 may be rotated at speeds between about 50 rpm and about 2000 rpm. The rotating speeds of the pin tool 16 are also dependent upon thickness of the workpiece 18 to be friction stir welded. Typically, higher speeds are used with thinner sections and lower rotational speeds are used with thicker sections. The pin tool 16 may partially protrude out of a tool holder 26. The tool holder 26 includes a shoulder 28 and an annular spindle 30. In a particular embodiment as shown in FIG. 1, the shoulder 28 may have a cylindrical shape. The shoulder 28 may plunge, rotate, and withdraw in coordination with or independent of the pin tool 16. In an example, the shoulder 28 may be non-rotating. The shoulder 28 may have an inside diameter that is slightly larger than the diameter of the pin tool 16 in order to accommodate the pin tool 16 without restriction. The shoulder 28 may also have an outside diameter that is larger than the diameter of the pin tool 16. In an embodiment, the shoulder 28 may include an outside diameter that is about two to three times the diameter of the pin tool 16. In an example, the spindle 30 may also have a cylindrical shape.

The spindle 30 may also have an inside diameter slightly larger than the diameter of the pin tool 16 in order to prevent any restriction. The length of the spindle 30 may be long enough in order to allow a sufficient length of pin tool 16 to be provided so as to produce a continuous weld. The spindle 30 may also include one or more channels 32 to provide a flow for a temperature controlling media. In a particular embodiment as shown in FIG. 1, the spindle 30 may include one channel 32. A cooling fluid cools the pin tool 16 and the shoulder 28. Some non-limiting examples of the cooling media may include air, inert gas, water, cooling oil and ethylene glycol. In order to contain the cooling fluid within the one or more channels 32 in the presence of rotating components, one or more seals 34 are used. In an example, the seals 34 may include an O-ring seal.

The pin tool 16 is plunged into the workpiece 18 and traversed along the joint 24 to be welded. The pin tool 16 provides a combination of frictional heat and thermo-mechanical working in order to accomplish a weld. As the pin tool 16 is traversed along the joint 24 to be welded, the joint vicinity becomes plasticized (non-liquid) and workpiece material from all components of the joint transfers across the joint interface 24, co-mingling to form a strong cohesive bond between all workpiece components through a localized solid-state forging and/or extrusion action.

The thermal management system 14 includes a backing plate 36 and a thermal control plate 38. The backing plate 36 forms a welding table on which the workpiece 18 is disposed. In an example, the backing plate 36 may include a steel plate. In a particular embodiment, a hard metal backing sheet 40 may also be disposed between the workpiece 18 and the backing plate 36. Some non-limiting examples of the hard metal backing sheet 40 include a sheet made of a tungsten alloy or a molybdenum alloy. The thermal control plate 38 disposed below the backing plate 36 provides cooling or heating to the workpiece 18 before, during, and/or after the weld, in order to control the imposed thermal profile, and hence microstructure of the workpiece 18 in a weld affected zone 42. The term ‘weld affected zone’ used herein refers to area within and around the joint 24 of the weld wherein microstructural properties of the workpiece 18 may be affected. During the welding process, the materials 20 and 22 being bonded may undergo transformations in microstructural properties such as grain size and grain orientation, phase morphology, phase content, and phase distribution. The thermal control plate 38 provides a method of thermal management to enable control over such microstructural properties.

In an illustrated embodiment of the invention as shown in FIG. 2, a diagrammatical illustration of a section of a thermal management system 14 as referenced in FIG. 1 is depicted. The thermal management system 14 includes a backing plate 36 as referenced in FIG. 1. The backing plate 36 includes an anchored rod 52 that physically supports the region to be welded. A weld joint may be located along a center of the rod 52 and extend along the length of the rod 52. In an example, the backing plate 36 may be made of a steel alloy and the rod 52 may be made of a tungsten alloy, or other refractory material. In another non-limiting example, the backing plate 36 and the rod 52 may be made of a steel alloy. In yet another non-limiting example, the rod 52 may be curvilinear to accommodate non-linear and/or contoured joints. In yet another embodiment, the welding apparatus 10 may include a pin tool 16 and a rod 52 made of tungsten alloy or steel alloy. In another embodiment, the diameter of the rod may vary between about 0.5 inches to about 2.5 inches. Typically, the weld is about one third of the width of the rod 52. The rod 52 may be clamped on the sides by metal strips 54 held on to the backing plate 36 by screws 56. Mounting holes 58 may be provided on the backing plate 36 in order to clamp the backing plate 36 to the thermal control plate 38. In a particular embodiment, the seals 34 may be disposed between the backing plate 36 and the thermal control plate 38 and further may be clamped together using multiple bolts.

A thermal control plate 38 as referenced in FIG. 1 is disposed below the backing plate 36. The thermal control plate 38 may provide heating or cooling of a weld affected zone by passing a temperature control media through conduits 60. Some non-limiting examples of temperature control media may include water, other fluids, and inert gas. In a particular embodiment, the thermal control plate 38 may be used to pre-heat, heat, and/or post-weld heat a weld affected zone in order to decrease the flow stress of the workpiece and/or control the post-weld cooling rate within the weld affected zone, and thus provide a desired microstructure or provide other benefits such as improved tool performance. In a non-limiting example of such an embodiment, heating may also be provided by multiple resistive heaters. Other non-limiting examples of heating methods may include passing a liquid or gas as a temperature control media, microwave heating, laser heating, ultrasonic heating and induction heating. In another embodiment, the thermal control plate 38 may be used to cool the weld affected zone in order to extract heat from the weld. In a non-limiting example of such an embodiment, water or any cooling fluid or gas may be flown through the conduits 60 of the thermal control plate 38. In a particular embodiment, multiple channels 62 may also be provided for the seals 34 to seal the backing plate 36 and the thermal control plate 38.

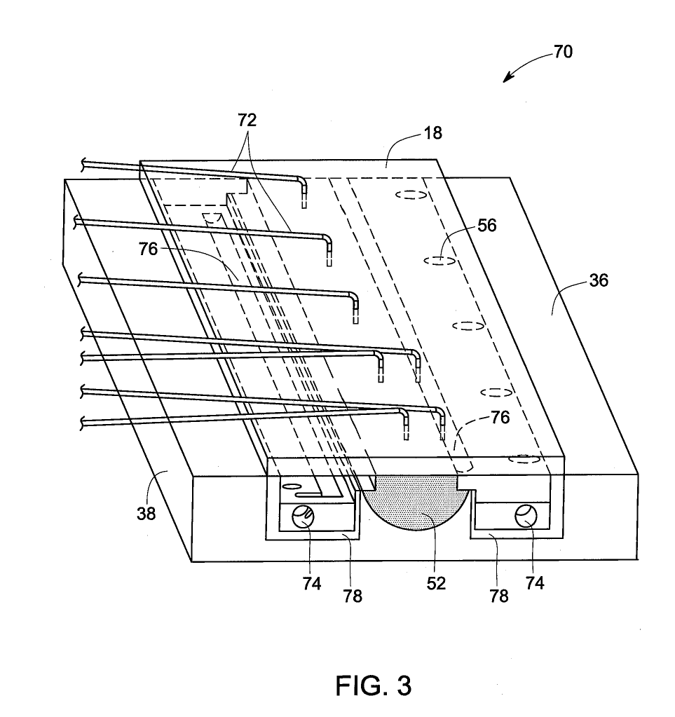

In another illustrated embodiment of the invention as shown in FIG. 3, a diagrammatic illustration of an exemplary thermal management system 70 is depicted. The thermal management system 70 includes multiple thermocouples 72 that are coupled to the workpiece 18 and the backing plate 36 as referenced in FIG. 1. The thermal management system 70 also includes multiple inlets 74 through the thermal control plate 38 as referenced in FIG. 1. A temperature control media may be passed through the inlets 74. In an example, heated argon gas may be passed though the inlets 74. The temperature control media further passes through conduits 76 in the thermal control plate 38. In a particular embodiment, inert gas can be passed through inlets 74, and subsequently conduits 76, to control the workpiece temperature and to shield the underside of the workpiece 18 from environmental attack. The thermocouples 72 may monitor temperature at a weld affected zone. Based upon the monitored temperature, parameters such as flow rate and temperature of the temperature control media that is passed through the thermal control plate 38 may be controlled. A heater and electrical insulation 78 such as a ceramic insulation may also be provided around edges of the thermal control plate 38.

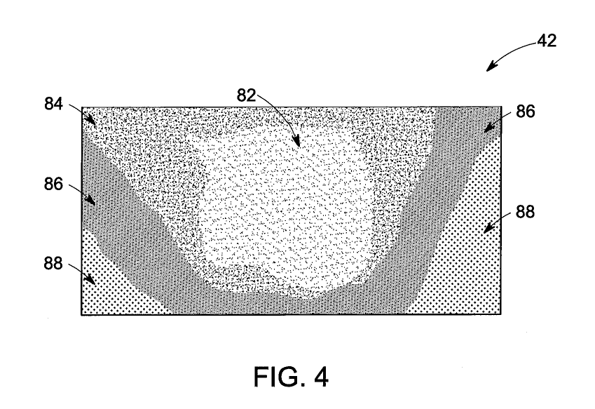

FIG. 4 is a diagrammatic illustration of various zones in a weld affected zone 42 as referenced in FIG. 1 looking down an axis of the weld affected zone 42 and along the length where the pin tool 16 traverses with the materials 20 and 22 as referenced in FIG. 1 being joined. A pin tool apparatus 12 as referenced in FIG. 1 is rotating about a vertical axis into a plane of the workpiece 18 as referenced in FIG. 1. The weld affected zone 42 includes a dynamically recrystallized zone (DRZ) 82 that is also referred to as a stir zone. The materials 20 and 22 of FIG. 1 may be mixed and stirred in the DRZ 82 through a localized solid-state forging and/or extrusion action. The weld affected zone 42 also includes a thermo-mechanically affected zone (TMAZ) 84. The thermo-mechanically affected zone 84 refers to an area affected primarily by changes in heat and mechanical deformation of the materials 20 and 22. In the zone 84, the materials 20 and 22 have already been plastically deformed to a large extent. The weld affected zone 42 further includes a heat affected zone (HAZ) 86. In the HAZ 86, the materials 20 and 22 undergo a change in microstructure due to the imposed thermal cycle. However, there is no plastic deformation occurring in the zone 86. Zone 88, also referred to as an unaffected zone, is an area of the materials 20 and 22 remote from the weld and does not undergo any deformation or change in microstructural properties during the friction stir welding process.

In the aforementioned thermal management system, temperature of the weld affected zone may be controlled as per a characteristic cooling curve in a material-specific CCT diagram, for instance, in order to achieve a desired microstructure. In general, the instantaneous temperature very near the pin tool is substantially different than that away from the pin tool. Consequently, a portion of the workpiece very near the pin tool may be at a substantially different position in time-temperature space along the most desirable cooling curve than a portion away from the pin tool. In order to actively control the microstructure in such cases, it may be necessary to impose various thermal gradients across the backing anvil. Such a requirement may be addressed by enabling segmented thermal control along a length of the backing plate and separately controlling temperature in each of the segments.

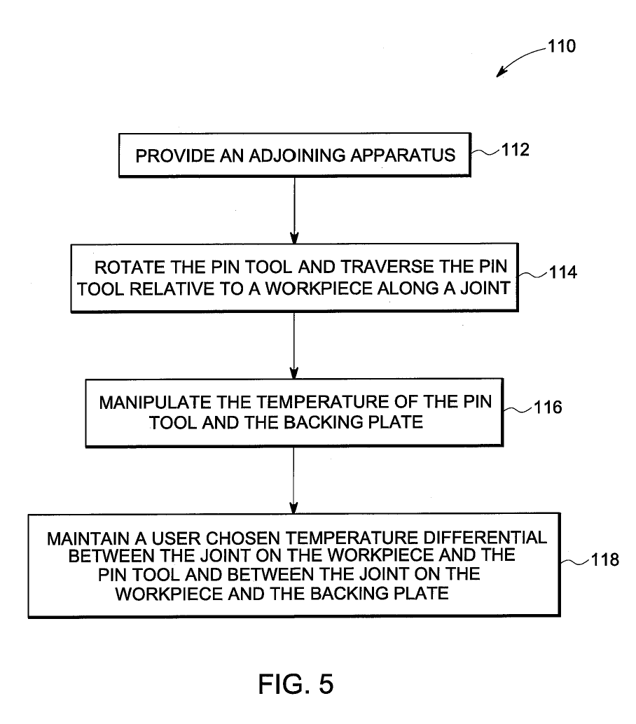

FIG. 5 is a flow chart representing steps involved in an exemplary method 110 for creating a solid state joint on a workpiece. The method 110 includes providing an adjoining apparatus in step 112. The adjoining apparatus may include a pin tool, a backing plate and a thermal control plate disposed below the backing plate. The pin tool is rotated and traversed relative to a workpiece along a joint to be welded on the workpiece in step 114. In a particular embodiment, the pin tool may be traversed relative to the workpiece that is stationary. In another embodiment, the pin tool may be stationary and the workpiece may be moved. In yet another embodiment, the pin tool and the workpiece may be moved. The temperature of the pin tool and the backing plate are manipulated in order to control the temperature profile of the workpiece and rate of change of temperature experienced by the workpiece at a weld affected zone at the joint in step 116.

In a particular embodiment, the temperature of the workpiece is manipulated before the pin tool is brought in contact with the joint. In another embodiment, the temperature of the workpiece is manipulated when the pin tool is in contact with the joint. In yet another embodiment, the temperature of the workpiece is manipulated after the pin tool has been in contact with the joint. In an example, the peak welding temperature may be limited below the beta-transus temperature of an alpha-beta titanium alloy, in order to prevent grain growth in the weld affected zone. In another example, the peak welding temperature may be limited below the austenitization temperature in steels, in order to avoid formation of a brittle martensite upon cooling. In yet another example, the post-weld cooling rate may be controlled to avoid the formation of deleterious phases within and around the weld affected zone. Further, controlling the temperature may include monitoring and controlling cooling rate of a temperature control media passed through the thermal control plate in accordance with a desirable cooling curve. In another example, controlling the temperature may include monitoring and controlling temperature of the temperature control media. In yet another example, controlling the temperature may also be provided by multiple strip heaters or multiple resistive heaters. The method 110 also includes maintaining a user chosen temperature differential between the weld affected zone and the backing plate via the thermal control plate in step 118. This helps in controlling any microstructural changes in the workpiece. Some non-limiting examples of controlling the microstructural changes may include controlling phase distribution and phase morphology, avoiding harmful phase transitions and controlling grain size of the material in the workpiece.

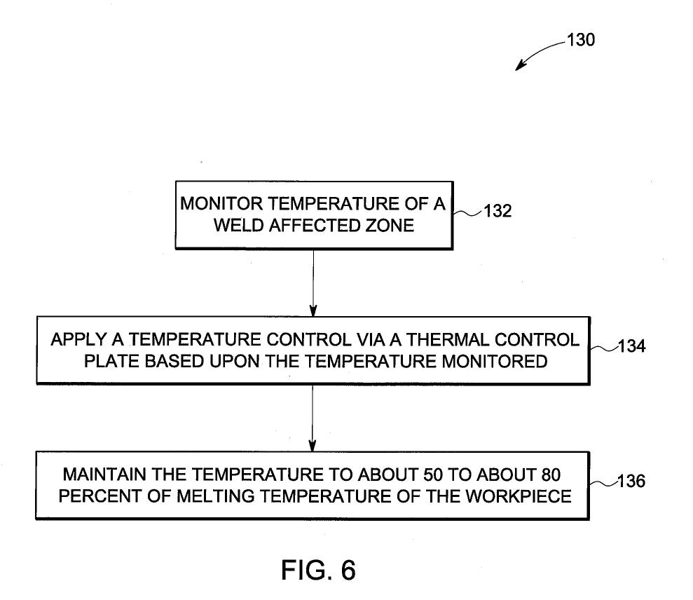

FIG. 6 is a flow chart representing steps involved in an exemplary method 130 for a method of controlling temperature during a process of creating a solid state joint. The method 130 includes monitoring temperature of a weld affected zone in step 132. In an example, a non-contact pyrometer may be used to monitor temperature of the weld affected zone. Based upon the monitored temperature, a temperature control is applied to the weld affected zone via the thermal control plate in step 134. In a particular embodiment, a temperature control is applied before a welding operation. In another embodiment, a temperature control is applied during a welding operation. In yet another embodiment, a temperature control is applied after a welding operation. Controlling the temperature of the weld affected zone may be achieved by controlling parameters of the thermal control plate. Some non-limiting examples of such parameters may include flow rate and temperature of a temperature control media that is being passed through the thermal control plate, and/or in conjunction with control of the typical friction stir weld parameters. In a particular embodiment, in a cooling process, the flow rate of a coolant may be increased in a desired manner so as to achieve the desired temperature control as well as the desired microstructure in a workpiece. In another embodiment, in a heating process, the temperature of the media flowing through the backing plate may be controlled so as to enable precipitation of fine alpha particles in a alpha-beta titanium alloy. In an example, the heating may be provided by multiple resistive heaters. Manipulating the temperature of said media enables temperature control over the backing plate. Some non-limiting examples of the temperature control media may be water, other fluids, heated or cooled gas, air and cooling oil. The temperature is maintained to about 50 to about 80 percent of melting temperature of the workpiece in step 136.

The various embodiments of a method for controlling microstructure via thermal management described above thus facilitate a way to improve or preserve material properties such as yield strength, tensile strength, ductility, impact toughness, fracture toughness, fatigue crack growth resistance, low cycle fatigue resistance, high cycle fatigue resistance, and superplastic formability of a friction weld and surrounding regions. This method also allows for improved in-situ control of structure and properties in a weld.

Of course, it is to be understood that not necessarily all such objects or advantages described above may be achieved in accordance with any particular embodiment. Thus, for example, those skilled in the art will recognize that the techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for creating a solid state joint comprising:
providing an adjoining apparatus, the apparatus comprising:
a pin tool;
a backing plate; and
a thermal control plate disposed below the backing plate;
rotating the pin tool and traversing the pin tool relative to a workpiece along a joint to be welded on the workpiece;
manipulating the temperature of the pin tool and the backing plate in order to control the temperature and rate of change of temperature experienced by the workpiece at a weld affected zone at the joint; and
maintaining a user chosen temperature differential between the weld affected zone and the backing plate via the thermal control plate.

2. The method of claim 1, wherein providing an adjoining apparatus comprises providing at least one conduit on the thermal control plate.

3. The method of claim 1, wherein providing an adjoining apparatus comprises providing an anchored rod to clamp the workpiece.

4. The method of claim 1, wherein manipulating the temperature comprises controlling the temperature and rate of change of temperature in the weld affected zone in order to control microstructure of the workpiece.

5. The method of claim 4, wherein manipulating the temperature in the weld affected zone in order to control microstructure comprises controlling grain size in the workpiece.

6. The method of claim 4, wherein manipulating the temperature in the weld affected zone in order to control microstructure comprises controlling phase composition and spatial distribution in the workpiece.

7. The method of claim 4, wherein manipulating the temperature in the weld affected zone in order to control microstructure comprises avoiding harmful phase transition in the workpiece.

8. The method of claim 1, wherein manipulating the temperature comprises passing a temperature control media through the thermal control plate.

9. The method of claim 8, wherein the temperature control media comprises a fluid.

10. The method of claim 1, wherein manipulating the temperature comprises monitoring a flow rate of the fluid.

11. The method of claim 8, wherein manipulating the temperature comprises monitoring temperature of the temperature control media.

12. The method of claim 9, wherein temperature control media are selected from a group consisting of air, a gas, water and cooling oil.

13. The method of claim 9, wherein temperature control media are selected from a group consisting of one or more strip heaters and a resistance heated metal strip.

14. The method of claim 1, wherein manipulating the temperature comprises limiting the peak temperature of the weld affected zone in the range between about 50 to 80 percent of the melting temperature of the workpiece.

15. The method of claim 1, wherein manipulating the temperature comprises manipulating the temperature of the workpiece before the pin tool is brought in contact with the joint.

16. The method of claim 1, wherein manipulating the temperature comprises manipulating the temperature of the workpiece when the pin tool is in contact with the joint.

17. The method of claim 1, wherein manipulating the temperature comprises manipulating the temperature of the workpiece after the pin tool has been in contact with the joint.

18. A method of operation comprising:
monitoring temperature of a weld affected zone;
applying a temperature control via a thermal control plate based upon the temperature monitored; and
maintaining the temperature to about 50 to about 80 percent of melting temperature of the workpiece.

19. The method of claim 18, wherein monitoring comprises monitoring temperature via a non contact pyrometer.

20. The method of claim 18, wherein applying a temperature control comprises controlling a plurality of parameters of the thermal control plate.

21. The method of claim 20, wherein the plurality of parameters comprises flow rate and temperature of a temperature control media passed through the thermal control plate.

22. The method of claim 21, wherein the temperature control media comprises air, an inert gas, water, other fluids, and cooling oil.

23. The method of claim 18, further comprising applying a temperature control via controlling the temperature of a friction stir welding tool.

24. The method of claim 18, wherein applying a temperature control comprises applying a temperature control before welding.

25. The method of claim 18, wherein applying a temperature control comprises applying a temperature control during welding.

26. The method of claim 18, wherein applying a temperature control comprises applying a temperature control after welding.
